(19) United States
(12) Patent Application Publication
(10) Pub. No.: US 2026/0116195 A1
(43) Pub. Date: Apr. 30, 2026

(54) WINCH SYSTEM FOR A VEHICLE

(71) Applicant: SCOUT MOTORS INC., Tysons, VA (US)

(72) Inventors: Victor Rangel, Commerce Charter Township, MI (US); Bryan Morton, Saline, MI (US); Daniel Davis, West Bloomfield Township, MI (US); Jason Seely, Troy, MI (US); Christoph Greskamp, Township of Northville, MI (US)

(21) Appl. No.: 18/933,304

(22) Filed: Oct. 31, 2024

Related U.S. Application Data
(63) Continuation of application No. 18/933,121, filed on Oct. 31, 2024.

(51) Int. Cl. B60L 1/00

(52) U.S. Cl. CPC B60L 1/003

(57) ABSTRACT

Provided herein is an apparatus, system, and method for operation of a vehicle winch, and more particularly, for controlling a winch power supply to a winch of a vehicle based on one or more conditions of the vehicle or an environment of the vehicle. Methods can include: receiving an indication that the winch is present; receiving an input indicating winch operation is requested; determining at least one condition of a vehicle associated with the winch; and enabling power to the winch in response to the at least one condition of the vehicle satisfying a predetermined requirement. The at least one condition can include a vehicle speed, and where the predetermined requirement comprises a vehicle speed below a predetermined threshold.

### CROSS-REFERENCE TO RELATED APPLICATIONS

This application is a continuation of and claims priority to U.S. patent application Ser. No. 18/933,121, filed on Oct. 31, 2024, the contents of which are hereby incorporated by reference in their entirety.

### BACKGROUND

Vehicles, and particularly vehicles designed for off-road use, can be equipped with powered winches. A powered winch can be used for a variety of purposes on a vehicle including, primarily, the extraction of stuck vehicles. “Extracting” a stuck vehicle can generally refer to self-recovery (e.g., in which a vehicle extracts itself from a stuck position) and/or assisted recovery (e.g., in which a second vehicle helps to extract a first vehicle from a stuck position). For example, vehicle self-recovery can involve extricating a vehicle using the vehicle's equipped winch from a location or position from which the vehicle is incapable of advancing itself out of using only the motive force of the wheels and tires. A winch can be employed for vehicle self-recovery by securing a cable of the winch to a stationary object and drawing the cable into the winch to pull the vehicle out of the immobile position. Similarly, a winch on a first vehicle can be used to help extract a second vehicle from a stuck position, in which case the winch on the first vehicle is attached to the second vehicle instead of or in addition to being attached to a stationary object. A winch system can optionally be used for navigating challenging terrain where tire traction may not be effective in overcoming obstacles, such as in rock crawling. In such an embodiment, the winch system can aid propulsion.

### SUMMARY

A system and method are therefore provided for operation of a vehicle winch, and more particularly, for controlling a winch power supply to a winch of a vehicle based on one or more conditions of the vehicle or an environment of the vehicle. An embodiment provided herein includes an apparatus including at least one processor and at least one non-transitory memory including computer program code instructions, the computer program code instructions configured to, when executed by the at least one processor, cause the apparatus to: determine that operation of a winch is requested; determine at least one condition of the vehicle associated with the winch in response to the operation of the winch is requested; and enable power to the winch in response to the at least one condition of the vehicle satisfying a predetermined requirement.

Causing the controller of some embodiments to enable power to the winch includes causing the controller to provide a signal to at least one of a relay or a solenoid connecting a power source to the winch. According to some embodiments the at least one condition includes one or more of a vehicle operating mode, a vehicle speed, a vehicle power mode, or a vehicle power status. According to certain embodiments the at least one condition includes a vehicle speed, and wherein the predetermined requirement comprises a vehicle speed below a predetermined threshold.

According to some embodiments the at least one condition includes a vehicle power mode, wherein the vehicle power mode comprises at least an off mode, an accessory enable mode wherein accessories are powered and the vehicle cannot be driven, and a run mode wherein accessories are powered and the vehicle can be driven, wherein the predetermined requirement includes the vehicle operating in the run mode. According to certain embodiments the at least one condition is determined based on one or more signals received from at least one sensor of the vehicle.

The apparatus of an example embodiment is further configured to determine at least one condition of an environment of the vehicle and enable power to the winch in response to the at least one condition of the vehicle satisfying the predetermined requirement and the at least one condition of the environment of the vehicle satisfying a predefined criteria. According to some embodiments the predefined criteria comprises an absence of people or wildlife objects within an area of concern comprising a predefined area proximate the winch of the vehicle.

Embodiments provided herein include a vehicle including: a winch; a winch controller; and a winch power supply, wherein the winch controller is configured to: determine that operation of a winch is requested; determine at least one condition of the vehicle in response to the input indicating operation of the winch is requested; and enable power to the winch from the winch power supply in response to the at least one condition of the vehicle satisfying a predetermined requirement.

According to some embodiments the at least one condition of the vehicle includes a speed of the vehicle, and wherein the predetermined requirement includes a speed of the speed of the vehicle below a predetermined threshold. The at least one condition of an example embodiment includes a vehicle power mode, where the vehicle power mode comprises at least an off mode, an accessory enable mode where accessories are powered and the vehicle cannot be driven, and a run mode wherein accessories are powered and the vehicle can be driven, where the predetermined requirement comprises the vehicle operating in the run mode.

The winch controller of some embodiments is further configured to: determine at least one condition of an environment of the vehicle and enable power to the winch in response to the at least one condition of the vehicle satisfying the predetermined requirement and the at least one condition of the environment of the vehicle satisfying a predefined criteria. According to certain embodiments the predefined criteria includes an absence of people or wildlife objects within an area of concern around the winch.

The winch power supply of some embodiments includes a winch battery and a battery charger and where the vehicle is an electric vehicle and further includes: an electric powertrain comprising a battery and at least one electric motor; a direct current (DC) to alternating current (AC) converter, wherein DC to the DC-to-AC converter is provided by the battery, and wherein the AC is provided to the battery charger.

Embodiments provided herein include a method of operating a winch including: determining that the winch is present; determining that operation of a winch is requested; determining at least one condition of a vehicle associated with the winch; and enabling power to the winch in response to the at least one condition of the vehicle satisfying a predetermined requirement.

According to some embodiments the at least one condition includes a vehicle speed, and where the predetermined requirement comprises a vehicle speed below a predetermined threshold. The at least one condition of an example embodiment includes a vehicle power mode, where the vehicle power mode comprises at least an off mode, an accessory enable mode where accessories are powered and the vehicle cannot be driven, and a run mode wherein accessories are powered and the vehicle can be driven, where the predetermined requirement includes the vehicle operating in the run mode. The method of some embodiments further includes determining at least one condition of an environment of the vehicle and enabling power to the winch in response to the at least one condition of the vehicle satisfying the predetermined requirement and the at least one condition of the environment of the vehicle satisfying a predefined criteria.

Embodiments provided herein include an electric vehicle including: an electric powertrain having a battery and at least one electric motor; a winch; a winch power supply comprising a winch battery and a battery charger; a direct current (DC) to alternating current (AC) converter, wherein DC to the DC-to-AC converter is provided by the battery, and wherein the AC is provided to the battery charger. The electric vehicle of some embodiments further includes a controller, where the controller is configured to: receive an input indicating winch operation is requested; determine at least one condition of the vehicle in response to the input indicating winch operation is requested; and enable power to the winch from the winch power supply in response to the at least one condition of the vehicle satisfying a predetermined requirement.

According to some embodiments the battery of the powertrain is a high-voltage battery of more than 100-volts, wherein the winch battery is less than 50-volts.

The electric vehicle of some embodiments further includes an accessory system including an accessory battery, wherein the accessory battery is less than 50-volts. The electric vehicle of some embodiments further includes a winch controller, wherein the winch controller receives power from the winch power supply and controls operation of the winch.

The electric vehicle of some embodiments further includes a solenoid between the winch power supply and the winch controller regulating the supply of power to the winch controller. The electric vehicle of some embodiments further includes a vehicle controller, where the solenoid is controlled by the vehicle controller to enable and disable power from the winch power supply to the winch controller. According to some embodiments the vehicle controller controls power from the winch power supply to the winch controller based on at least one condition of the electric vehicle satisfying a predetermined requirement.

According to some embodiments the at least one condition includes one or more of a vehicle operating mode, a vehicle speed, a vehicle power mode, or a vehicle power status. According to certain embodiments the at least one condition includes a vehicle speed, and where the predetermined requirement comprises a vehicle speed below a predetermined threshold. According to certain embodiments the at least one condition is determined based on one or more signals received from at least one sensor of the vehicle.

Embodiments provided herein include a method of operating an electric vehicle including: powering an electric powertrain of the electric vehicle with a battery; powering a winch of the electric vehicle with a winch power supply; converting direct current (DC) from the battery to alternating current (AC) using a DC-to-AC converter; powering a battery charger of the winch power supply with AC from the DC-to-AC converter; and charging a winch battery of the winch power supply with the battery charger.

The method of operating an electric vehicle of some embodiments further includes: receiving, at a controller, an input indicating winch operation is requested; determining at least one condition of the electric vehicle in response to the input indicating winch operation is requested; and enabling, with the controller, power to the winch from the winch power supply in response to the at least one condition of the vehicle satisfying a predetermined requirement.

The method of operating an electric vehicle of some embodiments further includes: regulating power to the winch by the controller using at least one of a relay or a solenoid between the winch power supply and the winch. According to some embodiments the at least one condition includes one or more of a vehicle operating mode, a vehicle speed, a vehicle power mode, or a vehicle power status. According to certain embodiments the at least one condition includes a vehicle speed, and wherein the predetermined requirement comprises a vehicle speed below a predetermined threshold.

The method of operating an electric vehicle of some embodiments further includes determining the at least one condition based on one or more signals received from at least one sensor of the vehicle. According to certain embodiments the battery of the powertrain is a high-voltage battery of more than 100-volts, wherein the winch battery is less than 50-volts. The method of operating an electric vehicle of some embodiments further includes powering accessories of the vehicle other than the winch with an accessory system comprising an accessory battery, wherein the accessory battery is less than 50-volts. According to some embodiments accessories of the vehicle other than the winch comprise an advanced driver assistance system (ADAS).

### DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 illustrates a block diagram of a vehicle and control system thereof that facilitates operation of a winch system according to an example embodiment of the present disclosure;

FIG. 2 illustrates a winch system including a winch power supply according to an example embodiment of the present disclosure;

FIG. 3 illustrates a top-view of a vehicle including a winch as secured to another object according to an example embodiment of the present disclosure;

FIG. 4 illustrates a message flow diagram involving a winch system and a vehicle according to an example embodiment of the present disclosure;

FIG. 5 is a logic flow diagram of operation of a winch according to an example embodiment of the present disclosure;

FIG. 6 is another logic flow diagram of operation of a winch according to an example embodiment of the present disclosure;

FIG. 7 illustrates a top-view of a vehicle including a winch as secured to another object and an area of concern proximate the winch according to an example embodiment of the present disclosure;

FIG. 8 is a logic flow diagram of operation of a winch associated with an area of concern according to an example embodiment of the present disclosure;

FIG. 9 illustrates a logic flow diagram of a routine executed by a controller controlling operation of a winch according to an example embodiment of the present disclosure;

FIG. 10 is a flow chart of a process for operating a winch system according to an example embodiment of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

Embodiments described herein generally relate to a vehicle winch system of a vehicle, and more particularly, to controlling a winch of a winch system based on feedback from at least one sensor associated with the vehicle. Embodiments described herein further provide power to the winch system via a dedicated power supply, whereby the dedicated power supply can be charged using the high voltage system of an electric vehicle.

A vehicle winch generally includes a housing, within which is a spool around which a cable having a high tensile strength is wound. The spool may be driven by a variety of drive configurations, such as purely electric drives or hydraulic/electric drives. In a purely electrically driven winch, an electric motor is coupled to the spool, possibly through a gear box or gear reducer. This configuration is relatively simple. Hydraulic winches employ an electric motor to function as a hydraulic pump, where the hydraulic pressure generated by the hydraulic pump is used to drive the spool. In either type, the power from the vehicle is provided in the form of electricity.

The power consumption of a winch, regardless of drive type, is based on the amount of load exerted by the winch to wind the cable around the spool. In the case of vehicle self-recovery, for example, this can mean that the gross vehicular weight of a vehicle is the weight pulled by the winch, compounded by both an angle at which the cable is pulling and the position from which the vehicle being extracted is being drawn. For example, pulling a vehicle up a grade generates more load on the winch than pulling a vehicle along a flat surface, all else being equal. Similarly, pulling a vehicle through sand provides more resistance and greater load than pulling a vehicle across a low-friction surface such as snow or ice.

Vehicle winches are generally powered by a low voltage system of the vehicle that provides power to a winch motor of the winch to wind a winch cable about a drum. These low voltage systems are typically 12-volt systems in most vehicles; however, 24-volt winches are used in many heavier duty applications. Such winches use an electric motor providing sufficient torque to move a vehicle from a stuck position by pulling a winch cable that is secured to an anchor point. The power draw of the winch is dependent upon the load placed on the motor and a duration of the pull. The mere spooling of an unloaded cable of a typical 9,000-pound winch can draw 60-70 amps, while at max load pulling 9,000 pounds, the same winch can draw 450 amps. This power draw is significant and taxing on the low voltage electrical system of a vehicle.

Low-voltage vehicle systems, such as 12-volt DC (direct current) systems generally power accessories such as lights, infotainment systems (including navigation systems, sound systems, etc.), windows, door locks, etc. In conventional ICE (internal combustion engine) vehicles and hybrid vehicles employing ICE engines, the low-voltage system provides energy to power the starter to crank the ICE engine ahead of firing along with powering the fuel pump. In electric-only vehicles or BEVs (battery electric vehicles), the low-voltage system may provide power to the accessory devices. However, in all vehicles, the low-voltage system typically provides power to the controllers of the vehicle, such as a vehicle controller which controls the powertrain of the vehicle and safety systems thereof. These low-voltage systems are therefore critical to safe operation of the vehicle.

High-draw accessories, such as a winch, can overwhelm a low-voltage system through immense current draw, which may draw power away from systems critical to vehicle function and potentially damage the low-voltage system. Conventional ICE vehicles often employ a high-capacity alternator to mitigate at least a portion of the current draw of a winch; however, such alternators are large and heavy. Further, BEVs do not employ such alternators as alternators are driven by ICEs running and can produce power while a vehicle is stationary, albeit at the expense of inefficient fuel consumption. Thus, embodiments described herein may include a separate power supply for a vehicle winch that is dedicated to the winch system and avoids drawing down power that is needed for the low-voltage systems critical to vehicle operation. Embodiments of the dedicated power supply are described further below.

Embodiments of the winch system described herein can also employ a controller that ensures safe operation of a winch when the winch is being used. The controller can ensure that the vehicle is operating in an appropriate manner for winch operation while also ensuring that an area of concern proximate the vehicle and winch during operation of the winch is clear of people and animals.

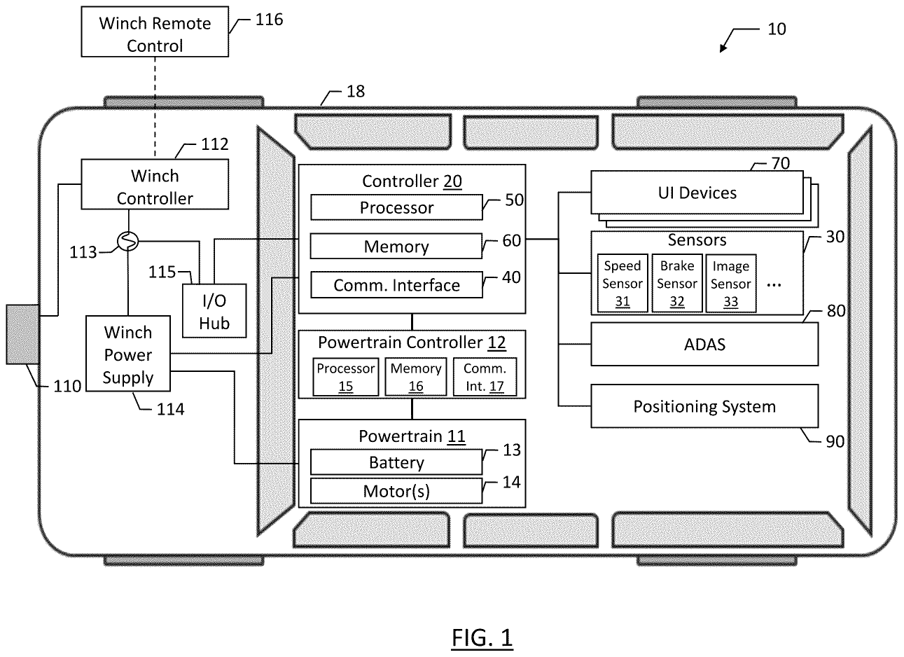

A winch system of example embodiments can include or be associated with a controller, whereby the controller functions to control operation of the winch. FIG. 1 is a schematic example of a vehicle 10 including components described herein for a winch system. It is appreciated that more or fewer components can be included in the system, and various components can be combined or separated into different components, such as sensors and controllers, for example.

As shown in FIG. 1, the vehicle includes a controller 20 which in some embodiments is integrated into the vehicle 10 and connected to different elements described herein, such as through a wiring harness. The illustrated controller 20 can be embodied as any controller of the vehicle 10 for controlling any features of the vehicle 10, with the depicted features of the illustrated embodiment being optional depending upon the application. For example, as mentioned above, the controller 20 can be embodied as an infotainment system controller, a vehicle controller, a powertrain controller, etc.; however, the present disclosure is not intended to be limiting in this regard. In other embodiments, the controller 20 could be a stand-alone controller or could be embodied via another vehicle controller, such as a vehicle control unit (VCU), an Advanced Driver Assistance System (ADAS) controller, or the like.

The controller 20 of FIG. 1 can be configured to perform any of the operations described herein. Controller 20 is an example embodiment that may be embodied by or associated with any of a variety of computing devices that include or are otherwise associated with a vehicle. The controller 20 can be in communication with any systems, sensors, or other controllers of the vehicle 10, such as via a communications interface (e.g., a CAN bus). According to some embodiments, the controller 20 can include a computing device that provides instructions or commands to a vehicle control module or other vehicle controller, where the controller is a device in communication with various vehicle systems and control architectures. In this manner, some embodiments can be implemented on purely in-vehicle systems, through mobile devices commanding in-vehicle systems, or a combination thereof. One such example is a winch operated by a remote device, such as a remote controller, smart phone, or the like, which may be used in embodiments described herein.

Optionally, the controller 20 may be embodied by or associated with a plurality of computing devices that are in communication with or otherwise networked with one another such that the various functions performed by the apparatus may be divided between the plurality of computing devices that operate in collaboration with one another.

The controller 20 may include, be associated with, or may otherwise be in communication with a communication interface 40, a processor 50, and a memory 60. The controller 20 may be in communication with one or more user interface devices 70, such as one or more displays that may include touch screen displays as part of a human-machine interface (HMI). In some embodiments, the processor 50 (and/or co-processors or any other processing circuitry assisting or otherwise associated with the processor) may be in communication with the memory 60 via a bus for passing information among components of the controller. The memory 60 may be non-transitory and may include, for example, one or more volatile and/or non-volatile memories. In other words, for example, the memory 60 may be an electronic storage device (for example, a computer readable storage medium) comprising gates configured to store data (for example, bits) that may be retrievable by a machine (for example, a computing device like the processor). The memory 60 may be configured to store information, data, content, applications, instructions, or the like for enabling the apparatus to carry out various functions in accordance with an example embodiment of the present disclosure. For example, the memory 60 could be configured to buffer input data for processing by the processor. Additionally or alternatively, the memory 60 could be configured to store instructions for execution by the processor.

The processor 50 may be embodied in a number of different ways. For example, the processor 50 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 50 may include multiple processors configured in tandem via the bus to enable independent execution of instructions, pipelining and/or multithreading.

In an example embodiment, the processor 50 may be configured to execute instructions stored in the memory 60 or otherwise accessible to the processor. Alternatively or additionally, the processor 50 may be configured to execute hard coded functionality. As such, whether configured by hardware or software methods, or by a combination thereof, the processor 50 may represent an entity (for example, physically embodied in circuitry) capable of performing operations according to an embodiment of the present disclosure while configured accordingly. Thus, for example, when the processor 50 is embodied as an ASIC, FPGA or the like, the processor 50 may be specifically configured hardware for conducting the operations described herein.

Alternatively, as another example, when the processor 50 is embodied as an executor of software instructions, the instructions may specifically configure the processor 50 to perform the algorithms and/or operations described herein when the instructions are executed. However, in some cases, the processor 50 may be a processor of a specific device (for example, the computing device) configured to employ an embodiment of the present disclosure by further configuration of the processor by instructions for performing the algorithms and/or operations described herein.

As noted above, the controller 20 of an example embodiment may also include or otherwise be in communication with one or more user interface devices 70. The user interface devices 70 can include any feature of the vehicle 10 that a user interacts with including features such as climate control, infotainment interface, gauge cluster, etc. In this regard, the user interface devices 70 may include or otherwise be in communication with one or more displays, such as an infotainment system display, a gauge cluster, an entertainment system display (e.g., for rear seat passengers) or the like. The user interface devices 70 may optionally include one or more speakers, physical buttons, analog display (e.g., speedometer, fuel gauge, etc.) and/or other input/output mechanisms. The user interface devices 70 may be incorporated into the vehicle 10, such as a dedicated navigation system display/audio system or a device that can attach or associate with the vehicle via communication link.

In an example embodiment, the processor 50 may include user interface circuitry configured to control at least some functions of one or more input/output mechanisms. The processor 50 and/or user interface circuitry comprising the processor 50 may be configured to control one or more functions of one or more input/output mechanisms through computer program instructions (for example, software and/or firmware) stored on a memory accessible to the processor (for example, memory 60, and/or the like).

As shown, the vehicle 10 may be equipped with any number of sensors 30, such as speed sensor 31, brake sensor 32, image sensor 33, etc. While the ADAS may include image sensors or proximity sensors, an image sensor that may be employed by embodiments described herein can include an infrared sensor to identify living things based on a heat signature. These sensors can be embodied by various types of sensors that collect data, where a speed sensor 31 can include a wheel speed sensor, optical sensor, hall effect sensor, etc. while the brake sensor 32 can include a sensor at a brake (e.g., at a brake caliper), a brake pedal, or within a brake line, etc., and the image sensor 33 can include a camera or an infrared sensor, for example. As described herein, a “sensor” refers to any sensing device which can be used to determine properties of the environment of the vehicle 10, properties of the vehicle itself, forces applied from/to the vehicle, or the like. Accordingly, the sensors 30 can include, but are not limited to, speed sensors 31, brake sensors 32, image sensors 33, as shown, and can include various other types of sensors.

It should be appreciated that the vehicle 10 may include a number of other sensors which may not be explicitly illustrated. For example, the vehicle 10 may include one or more of an accelerometer, a gyroscope, and a directional sensor to sense information regarding the movement, positioning, or orientation of the vehicle 10, e.g., for use in navigation assistance. In one such example, the vehicle 10 (or the controller 20 itself) could include an inertial measurement unit (IMU) that functions as an accelerometer and a gyroscope. The vehicle 10 may also include a light sensor, various image sensors (e.g., cameras), and more. As described in greater detail below, for example, the vehicle 10 may include various sensors and/or transceivers used for detecting a position, speed, etc. (e.g., for navigation) and/or for implementing various driving aids (e.g., parking sensors, radar for automatic cruise control and/or automated braking, cameras for lane center and object avoidance, etc.).

The controller 20 of an example embodiment may also optionally include a communication interface 40 that may be any means such as a device or circuitry embodied in either hardware or a combination of hardware and software that is configured to receive and/or transmit data from/to other electronic devices in communication with the controller 20. Additionally or alternatively, the communication interface 40 may be configured to communicate over any wired or wireless communication protocols. In some environments, the communication interface 40 may alternatively or additionally support vehicle to vehicle or vehicle to infrastructure wireless links.

The controller 20 of an example embodiment can be embodied by or otherwise in communication with various other vehicle controllers which can be separate or in a single module; however, it will be appreciated that these controllers function in concert to enable various aspects of vehicle functionality. As such, the controller 20 can be interpreted as a general controller performing each of these functions to enable vehicle functionality accordingly.

As shown, the vehicle 10 can further include an advanced driver assistance system (ADAS) 80 configured to perform various driver-assistance functions of a vehicle, including control features that may be part of autonomous control of a vehicle, such as adaptive headlight aiming, adaptive cruise control, lane departure warning and control, curve warning, and hazard warning, among others.

The ADAS 80 may be used to provide various functionality of a vehicle and may be implemented to improve the comfort, efficiency, safety, and overall satisfaction of driving. Some of these advanced driver assistance systems use a variety of sensors in the vehicle to determine the current state of the vehicle and the current state of the roadway ahead of the vehicle. These sensors may include radar, infrared, ultrasonic, and vision-oriented sensors such as image sensors and light distancing and ranging (LiDAR) sensors. According to some embodiments, and which may be particularly useful for off-road capable vehicle, the sensors of an ADAS 80 can include, for example, various cameras such as cameras directed to the wheels and terrain proximate the wheels to help guide a driver/occupant with respect to how to navigate challenging off-road terrain. These cameras can be in the vehicle and/or around the exterior of the vehicle, such as in a wheel arch, fender flare, wing mirror, bumper, brush guard, etc.

The vehicle 10 can optionally include a positioning system 90 which may be in communication with controller 20 as shown in FIG. 1. The positioning system can include any type of Global Navigation Satellite Systems (GNSS) such as the Global Positioning System (GPS), BeiDou Navigation Satellite System (BDS) positioning system, Galileo positioning system, or any other standardized positioning system. The positioning system 90 can optionally include systems that are not satellite-based, but use other methods of localization, such as wireless access point triangulation or the like. The positioning system 90 can be used in conjunction with the ADAS 80 or user interface devices 70 such as a navigation system, for example. The positioning system 90, if employing a highly accurate localization technique, may be able to determine speed of movement of the vehicle and/or may otherwise be used to supplement other speed of movement determinations (e.g., using wheel speed sensors). While vehicle speed can be discerned from GNSS, such vehicle speed is more accurate at relatively higher speeds (e.g., more than 20 miles per hour), while GNSS are not generally effective at very low speeds (e.g., less than 5 miles per hour), such that the positioning system 90 may be employed for low-speed determination only in certain circumstances.

FIG. 1 also illustrates a winch 110 of the vehicle 10. A conventional winch is typically a stand-alone unit that has no communication with the vehicle other than a power connection to power the winch from an existing 12-volt accessory system of the vehicle. According to embodiments of the present disclosure as shown in FIG. 1, the winch 110 can include a winch controller 112, and be powered by a winch power supply 114. Power to the winch controller 112 of the winch 110 from the power supply 114 may be controlled by the controller 20 through the I/O hub 115 which controls solenoid 113. The I/O hub 115 is a vehicle-side component that provides status information for connected input/output devices (e.g., a winch) and can provide control signals to the I/O devices. The I/O hub 115 is in communication with the controller 20 which provides instructions to the I/O hub. Further, the winch controller can be in communication, via wired or wireless communication, with a winch remote control 116 which can enable a user to operate the winch 110 outside of the vehicle 10 and while standing in a safe location. The winch power supply 114 can be a dedicated power supply as described in embodiments below, while in other embodiments the winch power supply can be based on the low-voltage accessory power system of the vehicle 10.

The vehicle 10 of FIG. 1 is embodied as an electric vehicle employing an electric powertrain 11 including a high-voltage battery 13 (e.g., a 400-volt or 800-volt battery pack) and one or more electric motors 14 for propelling the vehicle. The powertrain 11 can optionally include a powertrain controller 12 having a processor 15, memory 16, and communications interface 17 as described above in controller 20. In some embodiments the powertrain controller 12 may be incorporated into the controller 20. The powertrain controller 12 may function to control power from the battery 13 to the winch power supply 114, such as via the vehicle alternating current (AC) power bus as described further below.

As noted above, the winch system of embodiments described herein can include a winch 110 (including a winch motor) including a winch controller 112, and a winch power supply 114. A conventional winch power supply is the low-voltage accessory system of a vehicle, where a winch is wired into the accessory system via a 12-volt line that may be constant on or keyed on (e.g., receiving power in accessory mode or run mode). The power for a low-voltage accessory system of a vehicle is generally provided by a vehicle's battery which may be recharged by an alternator. However, according to an embodiment described herein, the winch power supply 114 is a dedicated power supply that supplies power only to the winch system.

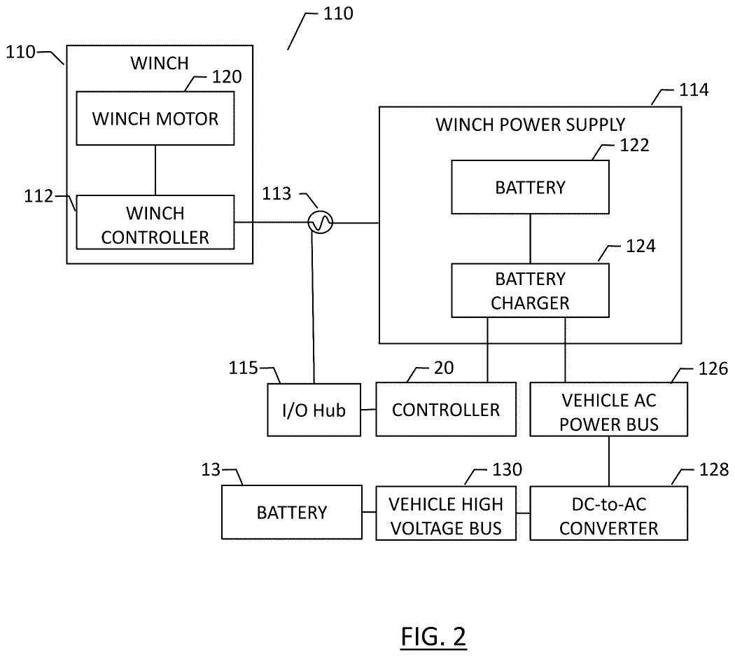

FIG. 2 illustrates the winch power supply 114 of an example embodiment in which the winch power supply is a dedicated power supply including a battery 122 which powers the winch 110 and winch motor 120 thereof via winch controller 112. Power to the winch controller 112 is enabled by a solenoid 113 controlled by I/O hub 115 which is in communication with the controller 20 as described above. The winch power supply 114 also includes a battery charger 124 configured to maintain the battery 122 in a fully charged state when possible. The battery charger 124 of the winch power supply 114 is powered by a vehicle AC (alternating current) power bus 126. The vehicle AC power bus 126 is a system that provides power to AC power outlets of a vehicle enabling the running of accessories, such as air compressors, tools, refrigerators, or any accessory a user may use away from a shore power source, where a shore power source is fed by an electrical grid.

The embodiment of FIG. 2 represents a winch power supply 114 of an electric vehicle having a high voltage battery system for providing motive power. In a conventional vehicle, the battery charger 124 may be supplied, for example, by the alternator of the vehicle. However, in the illustrated embodiment, the vehicle AC power bus 126 provides AC power to the battery charger 124. The battery charger functions as an AC-to-DC converter, to charge the battery 122. The vehicle AC power bus 126 is supplied by a DC-to-AC converter 128 which receives power from the vehicle high voltage bus 130 operating on high-voltage DC power from the vehicle battery 13.

The configuration of the winch power supply 114 described herein avoids the use of costly and heavy DC-to-DC conversion of the high-voltage DC power system of the vehicle to low-voltage DC power for the battery charger 124. For example, the high-voltage system of many electric vehicles is in the range of 400VDC to 800VDC. Thus, stepping down these sorts of high voltages to, e.g., 12VDC or 48VDC for charging the battery 122 would require an additional DC-DC converter which is heavy, complicated, and expensive. Instead, the winch power supply 114 described herein employs a battery charger 124 that uses conventional standard AC power (e.g., 110/220VAC, provided by DC-AC converter 128) to convert that AC power from the vehicle AC power bus 126 to low-voltage DC power. The low-voltage DC power is then used to charge the battery 122 This enables the winch system to be implemented as an optional accessory for a vehicle without requiring specifically configured hardware that goes unused if not optioned with the winch system. Such a configuration is desirable from a manufacturing standpoint as vehicles without the need for a winch system are not burdened the cost and complexity of extra hardware features that go unused, while those that opt for the winch system can have a complete winch system added to an existing vehicle architecture without requiring customization.

The winch system of example embodiments described herein may operate as a 12-volt DC winch, such that the battery 122 may be a 12-volt automotive battery used in conventional automotive systems. For example, a battery may be about 70 Amp-hours in some embodiments. However, embodiments can be configured in the same manner as described herein while using a 24-volt winch system without deviating from the fundamental winch system characteristics described herein. Such a system may use two 12-volt batteries charged by the same battery charger 124, for example. The charger of some example embodiments can be rated at, for example, around 50-100 Amps. The vehicle high voltage bus 130 of an example embodiment may operate on a voltage that is an order of magnitude greater than the winch system, such as a 400-volt high voltage bus or greater, such as an 800-volt high voltage bus. These high voltage examples are not limiting, but by way of example to demonstrate the DC voltage delta between the winch system and the high voltage bus of example embodiments.

Using a designated winch power supply 114 as described herein can improve vehicle performance. As described above, the power draw of the winch is dependent upon the load placed on the motor and a duration of the pull. The mere spooling of an unloaded cable of a typical 9,000-pound winch can draw 60-70 amps, while at max load pulling 9,000 pounds, the same winch can draw 450 amps. This power draw is significant and taxing on the low voltage electrical system of a vehicle. When a winch is connected to a 12-volt accessory system of a vehicle, the current draw for the winch can overwhelm the 12-volt system, drawing down the power available to other accessories operating on that system. These accessories can include safety features that become disabled when power is below a certain threshold. Further, other accessories can lose memory or settings when power is drawn down too far. Thus, embodiments described herein avoid drawing down power on a 12-volt accessory system by employing a dedicated winch power supply.

Power to the winch controller 112 of the winch 110 can be controlled by controller 20 via the I/O hub 115 using a solenoid 113 or relay. The status of the winch power supply 114 can be monitored, such as by controller 20 to determine if winch operation is possible and if the battery 122 charge is sufficient. The controller 20 can dictate if conditions for winch operation are appropriate in certain circumstances to allow the winch to be operated. If all conditions of operation of the winch 110 are satisfied, the controller 20 can indicate winch operation is enabled via the I/O hub 115 which enables power to the winch controller 112 of the winch 110 from the winch power supply 114 via solenoid 113. If any conditions of operation of the winch 110 are not satisfied, the controller 20 can indicate winch operation is disabled via the I/O hub 110 which disables power to the winch controller 112 via solenoid 113. Embodiments described below further detail how the controller 20 can be used to control operation of the winch system to improve safety and efficiency.

The winch system of a vehicle is generally used in situations in which the vehicle needs to pull itself out of a stuck position. This may be in an area where the vehicle has lost traction (e.g., sand, mud, snow, etc.), for example. Other situations where a winch system may be employed includes pulling other vehicles from stuck locations, or pulling an object that may need to be moved (e.g., a tree across a route). Regardless of the use, the winch system is almost entirely limited to low-speed or stopped vehicle conditions. However, most winches that are connected as an accessory are unaware of any vehicle conditions, such that the winches are operable when commanded by a user.

Embodiments described herein provide a system in which a vehicle can identify when winch use is appropriate and preclude use of the winch if any one of a number of criteria are met that indicate that winch use is inappropriate. Embodiments described herein use various sensors and signals from a vehicle to determine if winch use is appropriate, and to activate the winch system for operation when appropriate.

When a winch system is installed in vehicles of embodiments described herein, the winch system can be connected to a power supply, which may be the dedicated power supply described above, and may be connected to the vehicle controller 20 via the I/O hub 115 as shown in FIG. 1. The controller 20 can be made aware of the presence of the winch 110, such as through user input (e.g., via a user interface such as infotainment system) or the controller 20 may recognize the winch such as via connection of the winch system including the winch power supply 114 to the vehicle via a dedicated wiring harness or connection. Optionally, the winch may be recognized at the controller 20 by a flag set at the time of manufacture of the vehicle or during aftermarket installation and reprogramming of the controller 20.

Operation of the winch can include logic, as described herein, to indicate whether conditions for safe winch operation are satisfied, and if so, provide power to the winch controller 112 of the winch 110. If any conditions required for safe winch operation are not satisfied, the controller 20 can indicate as such and the solenoid 113 to provide power to the winch controller 112 can be opened to prevent power to the winch. Optionally, the winch function of a vehicle include a user interface, such as on UI devices 70 of FIG. 1, to be presented for graphical user interaction. In such an embodiment, a user may be able to select and control various properties of the winch operation. For example, a user may be able to select to enable or disable winch functionality from the graphical user interface such as selecting operation of a “winch mode” of the vehicle.

According to such an optional embodiment, the winch mode functionality may be a further condition that is satisfied for safe winch operation, and in such an embodiment, absent entering winch mode, power may not be supplied to the winch controller 112 of the winch 110.

As discussed herein, “winch mode” refers to a particular operating mode of vehicle 10 which affects operations of winch 110. In this regard, vehicle 10 may be operated in various operating modes (e.g., as controlled by controller 20 and/or other vehicle controllers) that define characteristics or settings of vehicle 10. For example, a “sport mode” may increase the throttle response, stiffen suspension, modify user interfaces, and/or otherwise affect the characteristics of vehicle 10. Likewise, responsive to a user activating “winch mode,” various characteristics and/or operations of vehicle 10 may change. For example, a central display of vehicle 10 may display a “winch mode” specific user interface, e.g., which displays relevant data such as winch power draw, vehicle speed, exterior camera views, etc. In addition, as discussed in greater detail below, operations of the powertrain of vehicle 10 may be adjusted or otherwise controlled in a manner different to a so-called “normal” operating mode of vehicle 10.

According to some embodiments, upon entering the winch mode, the vehicle may provide user interface controls and display elements that correspond to the winch mode. For example, when a vehicle is being winched, the vehicle may be in a situation in which there are obstacles (e.g., rocks, holes, etc.) such that a camera mode may be provided for display on a user interface. The camera mode may include displays depicting each of the wheels and the terrain the wheel is approaching and/or a display depicting the terrain immediately in front of or behind the vehicle. The winch mode may optionally display a speed of movement of the vehicle, a direction or heading, a vehicle inclinometer to illustrate a pose angle of the vehicle (fore/aft and/or side/side).

Upon entering the winch mode, the vehicle may control the brakes and/or wheels (e.g., via a controller 20) according to a position of the winch. Optionally, a driver of the vehicle may control the brakes and/or the wheels and speed thereof, though in winch mode, the control may be limited to predefined speeds. For example, a vehicle stuck on an incline may have the brakes applied, if an inclinometer indicates that the vehicle is on a slope, and the winch is drawing the vehicle uphill. In such a case, the vehicle may not release the brakes upon being placed in winch mode as the vehicle may slide down the incline. The brakes may be applied, for example, via powertrain controller 12 which can be electronically set, such as with an electronic parking brake. Instead, the vehicle may await determination, by the controller, of a force pulling the vehicle uphill to release the brakes. Such force determination may occur, for example, using an electric motor that drives one or more wheels detecting a torque in a direction indicating that the vehicle is being pulled uphill.

In the winch mode, if the vehicle is positioned on relatively level surface or where the brakes can be released without the vehicle moving with gravity, then the brakes may be released by a controller (e.g., powertrain controller 12) to place the vehicle into a neutral position where it can freely roll. The winch may be operated by a winch remote control (e.g., winch remote control 116), which may be a wired or wireless control operated by the vehicle operator or a person outside of the vehicle. Optionally, a winch control may be integrated into the user interface of the vehicle and operated through the user interface. Upon command by a user, vehicle operator or otherwise, via the winch controller, the winch may begin winding the cable back into the winch.

Winch operation may be limited by the controller 20 of the vehicle based on various conditions of the vehicle, the environment of the vehicle, or other conditions (e.g., winch power supply availability). The ultimate control of operation of the winch may be dictated directly or indirectly by the controller 20 based on the various conditions described herein, as to whether power is provided to the winch controller 112 of the winch 110 to permit operation of the winch system.

The conditions dictating whether winch operation is permitted may include a variety of conditions associated with the environment of the vehicle and/or the operational status of the vehicle. These conditions may be operational settings of a vehicle or determined conditions such as via sensor signals from various vehicle sensors. One such condition may be a vehicle mode of the vehicle. For example, if a vehicle is “keyed-off” where vehicle accessories are off and the vehicle cannot be driven, winch operation may be precluded by the controller 20. The controller 20 can, for example, indicate that the conditions necessary for safe winch operation are not satisfied such that the I/O hub 115 opens solenoid 113 preventing operation of the winch 110. This may preclude unspooling of a winch cable when the vehicle is off by locking the spool of the winch 110 to prevent tampering as the conditions to operate the winch safely are not satisfied. When the vehicle is in an Accessory mode (e.g., where accessories are operable but the vehicle is not moveable), winch 110 unspooling may be permitted (e.g., via a clutch opening between the winch motor and winch spool) even when all winch operation conditions are not satisfied, such as when a person is detected in front of the winch as described further below, though the winch may remain otherwise inoperable as a vehicle must typically be able to rotate the driven wheels during a winching operation, particularly when the purpose is extraction of the vehicle associated with the winch 110.

Winch operation may require a vehicle to be in a Run mode (e.g., where the vehicle is ready to be driven). Run mode includes when a vehicle is ready to be shifted to drive and to be driven. This mode may be determined by controller 20 responsive to a user providing the necessary inputs, such as applying pressure to the brake pedal and pressing a start/run button. Having the vehicle in Run mode may be a condition of the controller 20 for enabling winch operation. While the vehicle mode (Off/Accessory/Run) may be a condition of winch operation, other conditions also apply. For example, a vehicle speed condition may be required to be met for winch operation. This speed condition may be a threshold, such as a maximum speed (e.g., 25 kilometers per hour (kph)) below which winch operation is permitted while above which winch operation is not permitted. The speed of the vehicle may be determined by sensors (e.g., sensors 30) such as a wheel speed sensor. However, as a stuck vehicle may not have traction, the wheel speed may not be an accurate reflection of vehicle speed, such that other sensors may be used. A positioning sensor, LiDAR sensor (e.g., as part of the ADAS 80), or other such sensor may be used to establish vehicle speed or confirm a vehicle speed to satisfy the speed condition.

While winch operation may be permitted when vehicle speed is below a threshold, should the vehicle exceed the threshold speed, winch operation may be disabled. The speed threshold for activation of winch operation may be different than a speed threshold at which a winch is deactivated. For example, entering a winch mode in which winch operation is available may require a vehicle speed of less than 10 kph, while the vehicle may exit the winch mode when the detected vehicle speed exceeds 25 kph. This may be beneficial when vehicle speed is determined by a sensor such as a wheel sensor that may not accurately reflect what actual vehicle speed is.

Optionally, a vehicle operational mode may be a condition of winch operation permissibility. Vehicles that use winches are generally vehicle made to perform well off-road. Such vehicles may have different operational modes, such as a touring mode, a sport mode, and an off-road mode as examples of several possible operational modes. In a touring mode, suspension settings may be made to be compliant, while a ride height is relatively low. In a sport mode, the suspension settings may be stiffened, while a ride height may be further lowered. In an off-road mode, the suspension may be considerably softened, and the ride height may be significantly increased. In some cases, the touring mode or sport mode may be two-wheel drive modes, while the off-road mode is four wheel drive. These are merely examples of operational modes, and the modes may be more or fewer and vary in type.

According to some embodiments, an operational mode may be a condition of winch operation. Using the above operational mode examples, the winch functionality may be unavailable in sport mode or touring mode but may be operational in off-road mode. These operational modes can be selected by a user based on the type of terrain they encounter and based on other factors such as desired fuel efficiency, desired comfort level or handling level, etc. There may be additional modes in which winch operation is permitted, such as a snow/sand mode or other such mode focused on operation on unimproved surfaces.

In the case of an electric vehicle, another condition that may be required for the operation of the winch is a condition that the vehicle is not load shedding, whereby power of the vehicle is being reserved for essential functions. In the case of a battery electric vehicle where the battery provides the motive force, if the vehicle falls below a threshold state of charge the vehicle may enter load shedding functionality to improve the likelihood that the vehicle will be able to reach a charge point under its own power. Load shedding may be determined, for example, by the controller 20 and used as a condition that is required for providing power to the winch 110. Load shedding can be indicated based on a variety of conditions, such as a flag in the controller 20 which may be caused by a battery charge level which may be reported from the powertrain 11 via the powertrain controller 12. As winch operation may be safety-related, such as if a vehicle is being extracted from a remote location to drive to safety. In such a scenario, certain of the conditions described above may be overridden to enable winch operation. For example, while a vehicle is load shedding, the extraction of the vehicle may remain a priority for the vehicle operator. In such a case, the operator may override the disabling of winch operation during load shedding to permit the vehicle to be extracted. In such an embodiment, a user interface may caution the user as to the potential risks of overriding the winch disablement, such as by indicating that vehicle range may be significantly reduced.

The condition of a vehicle may be determined based on signals received from various sensors, such as sensors 30 or the ADAS 80, which may provide signals to the controller 20. The controller 20 can decipher the signals and determine if the conditions are satisfied for winch operation to proceed. Other sensors of a vehicle can be employed to determine various other conditions of the vehicle and the environment of the vehicle. The signal from these sensors can inform a controller 20 of the conditions such that the controller can determine if winch operation is appropriate.

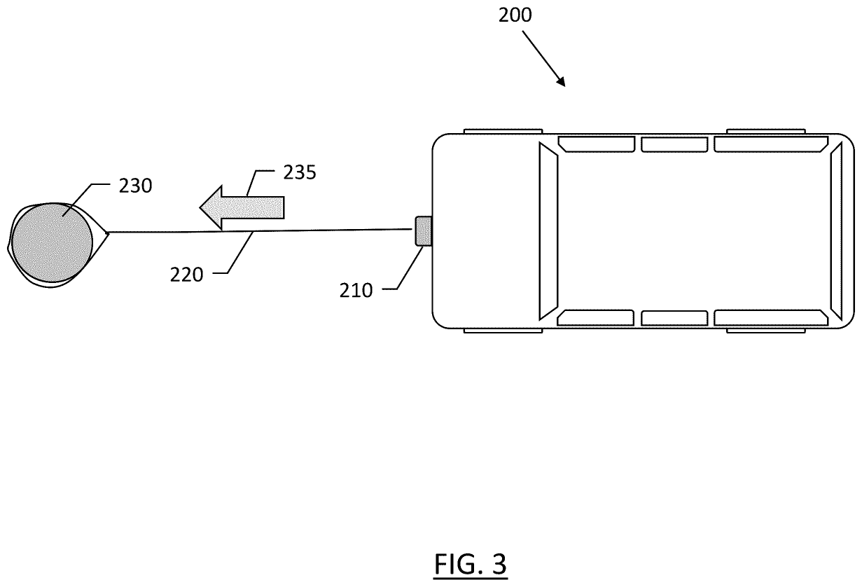

FIG. 3 illustrates an example embodiment of a vehicle 200 in a winching scenario. In the illustrated embodiment, a vehicle 200 includes a winch 210. The winch 210 of the illustrated embodiment may be controlled by a winch controller (e.g., winch controller 112 of FIGS. 1 and 2) to which power is provided from the winch power supply 114 as determined at a vehicle controller (e.g., controller 20). The winch 210 may be powered by a dedicated power supply as described above. The winch cable 220 is shown unspooled and secured around object 230 which is stationary. The winch cable 220 may be manually unspooled by a user. This may require the vehicle to be in at least the Accessory mode, and in some embodiments may require the vehicle to be in Run mode possibly with having entered winch mode through a user interface.

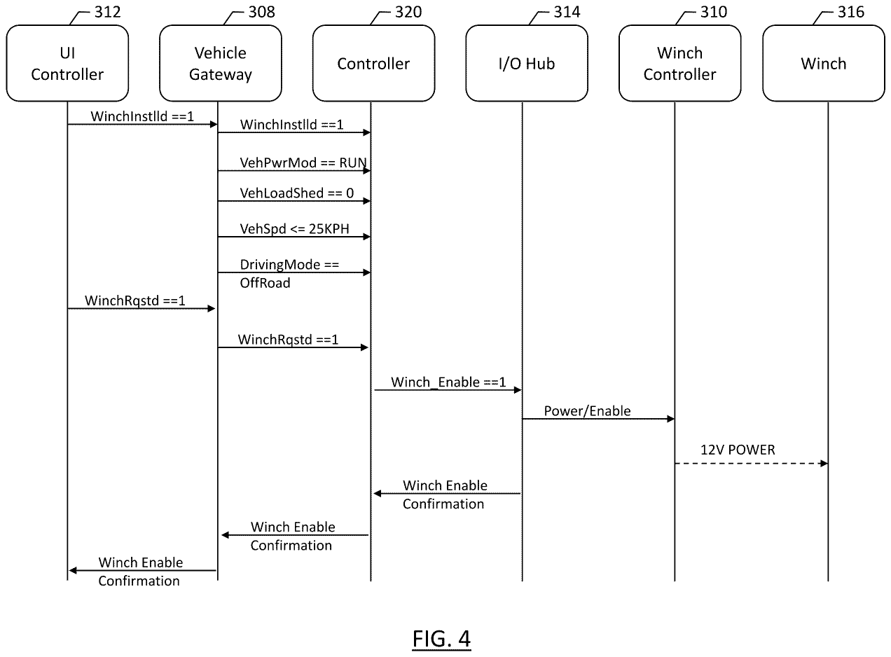

Once the winch cable 220 is secured to an object 230 and the user wants to begin winching, the winch logic may be followed employing the conditions described above. The winch logic signaling diagram of an example embodiment is shown in FIG. 4. As shown, the UI controller 312 is connected to the controller 320 via the vehicle gateway 308 which functions as the vehicle communication network. The UI controller 312, which may be embodied by or in communication with an infotainment system of a vehicle, signals to the gateway that the winch is installed (WinchInstlld==1). The vehicle gateway 308, receiving signals from other controllers and sensors of the vehicle, sends various signals to the controller 20. Those include in the winch control logic as shown: Winch installed (WinchInstlld==1), vehicle power mode is in Run (VehPwrMod==Run), vehicle load shedding is not occurring (VehLoadShed==0), that vehicle speed is less than 25 kph (VehSpd<=25 KPH), that the driving mode is set to off-road (DrivingMode==OffRoad).

The UI controller 312 indicates to the vehicle gateway 308 that winch operation was requested (WinchRqstd==1). This may be performed, such as through a graphical user interface of the vehicle, for example, requesting “winch mode” or a user providing an input at the winch, such as by interacting with the winch remote control 116 or the winch 110 itself. The vehicle gateway 308 indicates to the controller 320, which may be embodied by controller 20 of FIG. 1, that winch mode was requested. As the controller 320 has determined that the winch conditions have been met, the controller sends a winch enable command to the I/O hub 314 (Winch_Enable==1). The I/O hub 314 enables power from the winch power supply to the winch controller 310 (Power/Enable), such as via solenoid 113. The winch controller 310 then enables the winch 316. The winch 316 may be controlled by a remote control which may be a wired or wireless remote control for operating the winch. This can allow an operator to be located away from the winch itself during operation. In the case of a wired winch, the winch remote control may optionally be supplied with power (e.g., 12 V Power). However, in the embodiment of a wireless winch remote control, the signals from the winch remote control may be received and/or acknowledged only after winch controller 310 power is enabled. The I/O hub 314 confirms to the controller 320 that the winch was enabled (Winch Enable Confirmation) which is then communicated to the UI controller 312 via the vehicle gateway 308. The winch is then operational. The winch 316 can then receive commands from a user control such as forward or reverse, optionally along with speed controls.

The controller 20 described herein can enable or disable the winch by activating or deactivating power to the winch 110 via the winch controller 112 shown in FIG. 1 by the I/O hub 115 operating solenoid 113. Embodiments described herein further include safety features to protect both the vehicle and people or animals proximate the vehicle. One such feature protecting the vehicle includes a park pawl protection feature. The park pawl of a vehicle includes a pawl that engages one or more recesses of a wheel or gear to lock at least one wheel from turning. This at least one wheel may be, for example, on a shaft that is mechanically coupled to the rotation of at least one wheel, either directly or indirectly. The park pawl of an automatic transmission generally engages a gear within the transmission itself. In an electric vehicle may be within a transmission, within a motor, or may be exclusive of a motor or transmission. Regardless of location, the function of a park pawl is to mechanically lock at least one wheel and preclude that wheel from rotating.

Park pawls can wear or be damaged by excess pressure applied to the pawl. Such wear or damage can occur when the park pawl is engaged, and a vehicle is towed or winched without releasing the park pawl. When a vehicle is shifted to park, the park pawl is engaged. According to embodiments described herein, when a vehicle is in winch mode with the winch enabled, if the vehicle is shifted to park and the park pawl engaged, the winch may be disabled. This precludes the vehicle from being pulled by the winch with the park pawl engaged and one or more wheels locked and prevented from rotating. However, in certain circumstances, such as when the winch activity is pulling another vehicle from a stuck position, the vehicle with the winch may need to remain stationary. In such an embodiment, to protect the park pawl, when the vehicle is shifted to park and the winch is enabled, the vehicle may request brake application of either the parking brake or conventional brakes.

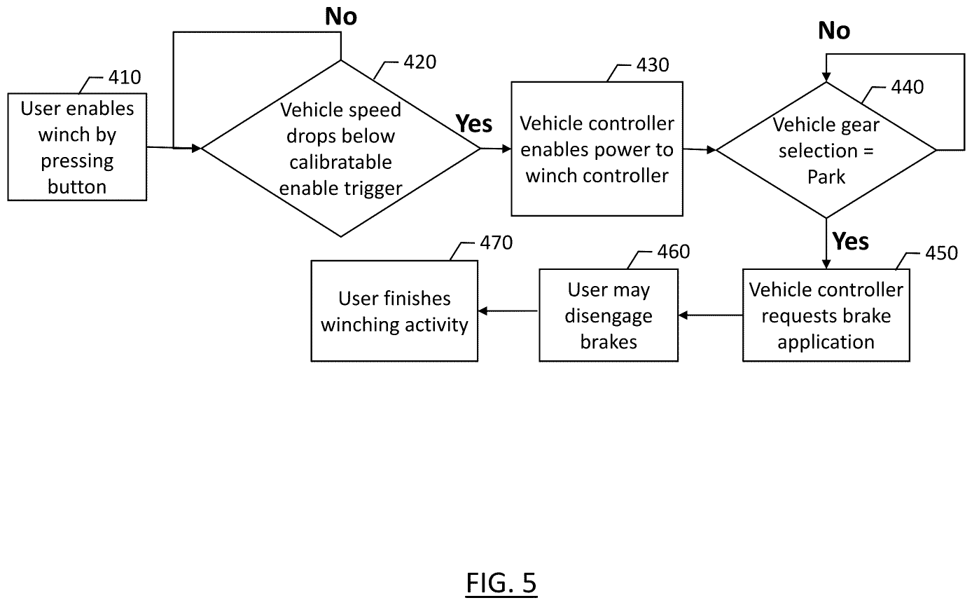

FIGS. 5, 6, and 8 depict logic flow diagrams of methods to example embodiments of the disclosure. It will be understood that each block of the diagrams, and combinations of blocks in the diagrams, may be implemented by various means, such as hardware, firmware, processor, circuitry, and/or other devices associated with execution of software including one or more computer program instructions. For example, one or more of the procedures described below may be embodied by computer program instructions. In this regard, the computer program instructions which embody the procedures described above may be stored by a memory, such as memory 60 of a controller 20 employing an embodiment of the present disclosure and executed by the processor 50 of the apparatus.

Accordingly, blocks of the diagrams support combinations of means for performing the specified functions and combinations of operations for performing the specified functions. It will also be understood that one or more blocks of the diagrams, and combinations of blocks in the diagrams can be implemented by various systems and components thereof, and blocks of the diagrams may be, in some cases, omitted, modified, reordered, etc.

FIG. 5 illustrates the logic flow diagram associated with an embodiment of the park pawl/lock protection according to an example embodiment. As shown, the winch may be enabled at 410, such as through the logic described above. Provided the vehicle speed detected at a vehicle speed sensor (e.g., speed sensor 31) is below a threshold speed at 420 and other associated conditions are met, the winch is enabled at 430 provided all other conditions are satisfied as described above. If not, the logic will await vehicle speed falling below the threshold speed. At 440, the logic determines if the vehicle is in park. The determination whether the vehicle is in park may be performed, for example, by the controller 20 which may receive a signal regarding park/reverse/neutral/drive status from the powertrain controller 12. If the vehicle is in park, the controller 20 requests brake application at 450. This may be done through the vehicle user interface, for example (e.g., UI devices 70). Application of the brakes during winch operation prevents force from being applied to the park pawl, and instead relies on the brakes to keep the wheels from rotating. A brake sensor (e.g., brake sensor 32) may determine when the brakes have been applied. At 460, an example embodiment may permit the vehicle user may disengage the brakes, and the vehicle may maintain the force of the brakes on the wheels (e.g., via the parking brake). This continues to keep the park pawl protected during the winching activity. At 470, the user may complete the winching activity.

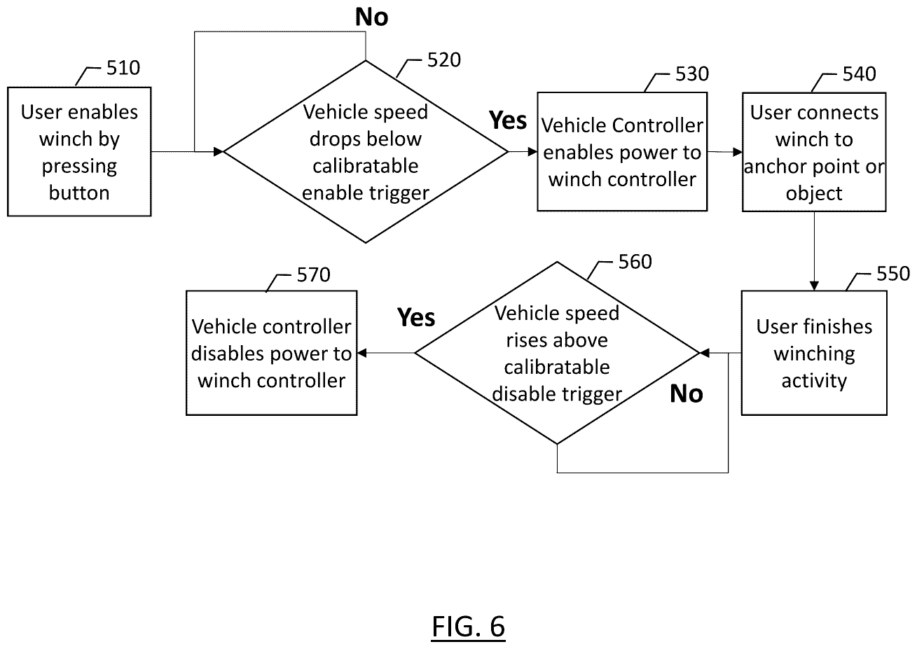

Embodiments described herein can employ logic that precludes the winch from operating when vehicle speed exceeds a predetermined value. FIG. 6 illustrates an example embodiment of logic corresponding to such a feature, where a user enables winch system at 510, such as using a user interface (e.g., UI devices 70). At 520, the vehicle controller, such as controller 20 which may receive signals from sensor 30 such as speed sensor 31, determines if the vehicle speed is below a predefined threshold. When the speed is below a predefined threshold, the vehicle controller (e.g., controller 20) enables power to the winch controller (e.g., winch controller 112 based on the I/O hub 115 operating solenoid 113) provided all other necessary conditions are satisfied. The user connects the winch to an anchor point or object at 540 by unspooling the winch cable. At 550 the user finishes the winching activity but does not disable the winch mode of the vehicle. However, at 560, the vehicle controller (e.g., controller 20) determines that the vehicle speed, such as using speed sensor 31, has exceeded a predetermined threshold, at which point the vehicle controller disables power to the winch controller at 570, such as through the I/O hub 115 and solenoid 113. According to some embodiments, if the vehicle speed remains above the threshold, the vehicle controller may automatically exit the winch mode and revert to the previous operational mode of the vehicle.

An example embodiment described herein further considers an area of concern safety condition for safe operation of a winch. When a winch is pulling, whether the winch is extracting the vehicle with the winch from a location, or the winching vehicle is stationary and pulling another object, there is some degree of risk of the winch cable breaking or otherwise coming free of the object to which the winch cable is attached. If the winch cable is under significant tension, the recoil of the winch cable can be very fast and potentially very damaging. As such, it is recommended that the area proximate a winch cable be kept clear during a winching operation. However, this is typically monitored by a person either directly in control of the winch or in communication with the person operating the winch.

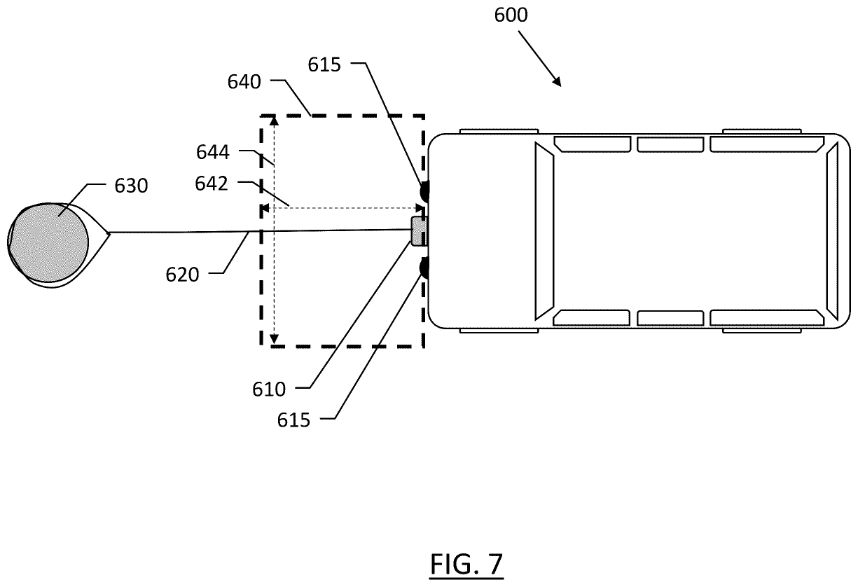

Embodiments described herein employ an area of concern and the absence of people and/or animals from this area as a condition of operation of the winch. Much in the same way various conditions must be satisfied to enable the winch as described with respect to FIGS. 4 and 5, ensuring a clear area of concern proximate the winch cable may be used as a further condition of winch operation. FIG. 7 illustrates an example embodiment of a vehicle 600 having a winch 610, where the winch cable 620 of the winch is secured around an object 630. The logic flow operations described above may be employed for activation or enablement of winch operation. However, an additional condition may need to be satisfied for enablement of winch operation. The area of concern 640 is illustrated as an area in front of the vehicle 600 around the winch 610. This area of concern 640 may be monitored by sensors 615, which may be sensors 30 of the vehicle 10 of FIG. 1. Such sensors can include image sensor 33 which may determine whether there is a living object within the area of concern, such as using an infrared image sensor detecting a heat signature. These sensors 615 may optionally include sensors that are typically used for autonomous or semi-autonomous vehicle control and are part of the ADAS 80, such as cameras, LiDAR sensors, proximity sensors, etc. The use of existing sensors reduces complexity of the vehicle architecture and the cost of implementing the winch system control described herein.

The area of concern may extend a predetermined distance 642 in front of the winch 610 and may extend a predefined distance 644 on either side of the winch 610. While the illustrated area of concern 640 is rectangular in shape, the area of concern may optionally be an arc of a predetermined distance in each direction forward of the winch 610 and may be longer in a direction in which the cable extends from the winch 610 in some embodiments. The area of concern may only be employed as a condition based on whether the winch is pulling above a predetermined force threshold. This strategy may be used as the winch cable is often retracted under little to no load as the cable is merely being retracted without being attached to an object. To determine if the cable is under tension, a current draw of the winch may be used to determine how much pulling force or tension is being applied to the winch cable. Current draw of a winch may be determined, for example, by controller 20 through the winch power supply 114 which can calculate current draw on the winch battery of the winch power supply during a winching operation.

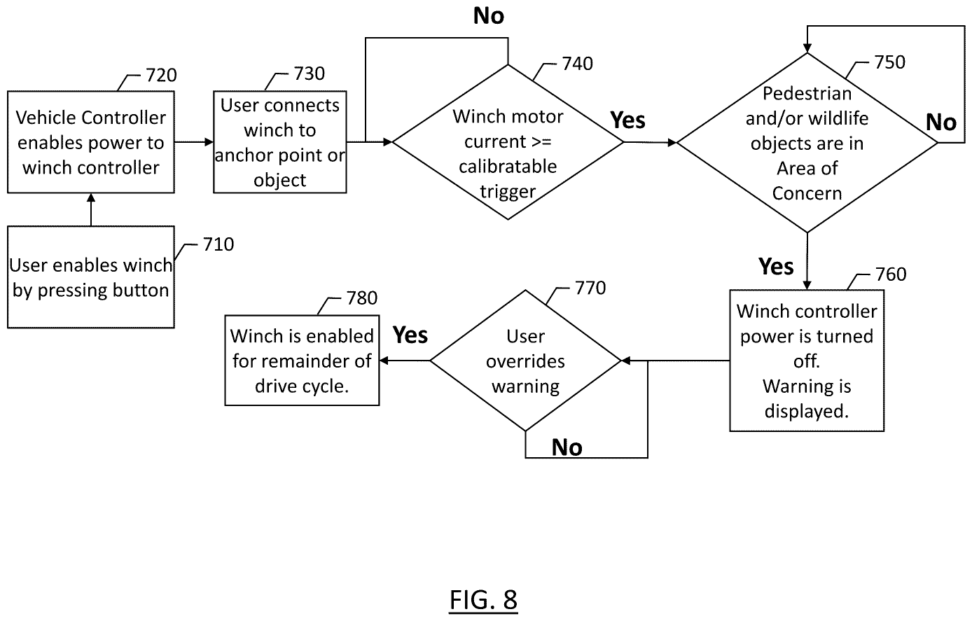

FIG. 8 illustrates the logic flow of an example embodiment employing an area of concern. As shown, a user enables winch mode at 710. The vehicle controller enables power to the winch controller at 720 provided all necessary conditions are met. At 730, the user connects the winch to an anchor point or object. At 740, a determination is made as to whether the winch motor current is above a predetermined calibratable trigger current. The winch motor current can be indicated to the controller 20 such as by the winch power supply 114 as the winch power supply can detect a drain on the battery 122 of the winch power supply and calculate current draw. This may be calibrated to establish a distinction between the winch pulling a very low load (or no load) versus pulling a significant load as when the winch is being used to actively extract a vehicle. If the current exceeds the trigger at 740, a determination may be made at 750 as to whether there are pedestrians or wildlife within the area of concern, such as by controller 20 using sensors 30 or employing the sensors associated with an ADAS determining the presence of or absence of objects, for example. If the area is clear, winch operation continues. If, while the winch current is still above the trigger, a pedestrian or wildlife object is detected within the area of concern, the winch controller power is turned off at 760, and a warning may be presented to an operator of the winch. The user may override the warning at 770, such as if the user determined that there is no danger present or if the detected person is present out of necessity. If the warning is overridden, the winch may remain enabled at 780.

Once enabled, the winch conditions must be maintained otherwise the winch will be disabled. FIG. 8 illustrates the logic loop for this confirmation which occurs at a high frequency, such as 60 Hz for example. The logic loop begins at 350 with the winch disabled before identifying the status of the conditions required for safe winch operation. If all conditions are satisfied at 355, the winch is enabled at 360. If any one of the winch conditions fails to be satisfied or becomes unsatisfied at 365, winch operation is disabled at 370.

Embodiments described herein provide an intelligent winch system control and logic that provides safe winch operation while ensuring that the conditions in and around a vehicle are appropriate for winch operation.

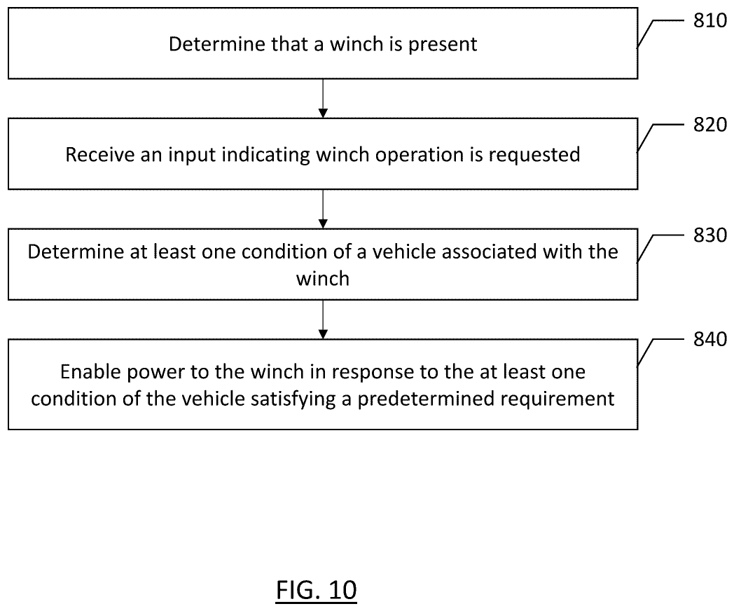

FIG. 10 illustrates a flowchart of a method for operation of a vehicle winch, and more particularly, for controlling a winch power supply to a winch of a vehicle based on one or more conditions of the vehicle or an environment of the vehicle. As shown, a determination is made that the winch is present at 810. This may be based on a vehicle controller receiving a signal from the winch (e.g., from the winch controller 112) or winch power supply 114, for example. An input indicating winch operation is requested is received at 820, whereby a user has requested winch operation, such as by entering a winch mode at a user interface or by commanding operation of the winch such as with a remote or wired control. At least one condition of a vehicle associated with the winch is determined at 830, whereby the controller of the vehicle can determine this condition such as with one or more sensors of the vehicle. The at least one condition can include a vehicle operational mode, vehicle speed, any objects in an area of concern, a park pawl indication, etc. as determined at the controller 20 from sensors 30, ADAS 80, or powertrain controller 12, for example. Power is enabled to the winch at 840 in response to the at least one condition of the vehicle satisfying a predetermined condition. The power may be enabled, for example, by controller 20 indicating to the I/O hub 115 that all conditions for safe operation of the winch are satisfied, and the I/O hub 115 enables power to the winch controller 112 of the winch 110 from the winch power supply 114 via solenoid 113.

As described above, FIG. 10 illustrates a flowchart of methods, computer program products, and systems according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory 60 of a controller 20 employing an embodiment of the present disclosure and executed by the processor 50 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks.

These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

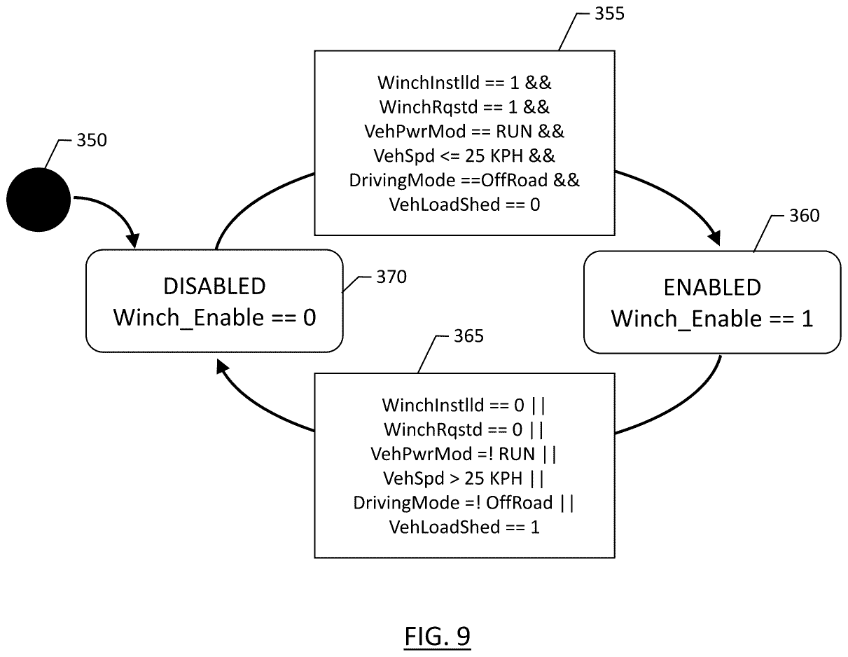

In an example embodiment, an apparatus for performing the method of FIG. 9 above may comprise a processor (e.g., the processor 50) configured to perform some or each of the operations (310-340) described above. The processor may, for example, be configured to perform the operations (310-340) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-340 may comprise, for example, the processor 50 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An electric vehicle comprising:
an electric powertrain comprising a battery and at least one electric motor;
a winch;
a winch power supply comprising a winch battery and a battery charger;
a direct current (DC) to alternating current (AC) converter, wherein DC to the DC-to-AC converter is provided by the battery, and wherein the AC is provided to the battery charger.

2. The electric vehicle of claim 1, further comprising a controller, wherein the controller is configured to:
receive an input indicating winch operation is requested;
determine at least one condition of the vehicle in response to the input indicating winch operation is requested; and
enable power to the winch from the winch power supply in response to the at least one condition of the vehicle satisfying a predetermined requirement.

3. The electric vehicle of claim 2, wherein the battery of the electric powertrain is a high-voltage battery of more than 100-volts, wherein the winch battery is less than 50-volts.

4. The electric vehicle of claim 3, further comprising an accessory system comprising an accessory battery, wherein the accessory battery is less than 50-volts.

5. The electric vehicle of claim 1, further comprising a winch controller, wherein the winch controller receives power from the winch power supply and controls operation of the winch.

6. The electric vehicle of claim 5, further comprising a solenoid between the winch power supply and the winch controller regulating the supply of power to the winch controller.

7. The electric vehicle of claim 6, further comprising a vehicle controller, wherein the solenoid is controlled by the vehicle controller to enable and disable power from the winch power supply to the winch controller.

8. The electric vehicle of claim 7, wherein the vehicle controller controls power from the winch power supply to the winch controller based on at least one condition of the electric vehicle satisfying a predetermined requirement.

9. The electric vehicle of claim 8, wherein the at least one condition comprises one or more of a vehicle operating mode, a vehicle speed, a vehicle power mode, or a vehicle power status.

10. The electric vehicle of claim 9, wherein the at least one condition comprises a vehicle speed, and wherein the predetermined requirement comprises a vehicle speed below a predetermined threshold.

11. The electric vehicle of claim 10, wherein the at least one condition is determined based on one or more signals received from at least one sensor of the vehicle.

12. A method of operating an electric vehicle comprising:
powering an electric powertrain of the electric vehicle with a battery;
powering a winch of the electric vehicle with a winch power supply;
converting direct current (DC) from the battery to alternating current (AC) using a DC-to-AC converter;
powering a battery charger of the winch power supply with AC from the DC-to-AC converter; and
charging a winch battery of the winch power supply with the battery charger.

13. The method of operating an electric vehicle of claim 12, further comprising:
receiving, at a controller, an input indicating winch operation is requested;
determining at least one condition of the electric vehicle in response to the input indicating winch operation is requested; and
enabling, with the controller, power to the winch from the winch power supply in response to the at least one condition of the vehicle satisfying a predetermined requirement.

14. The method of operating an electric vehicle of claim 13, further comprising:
regulating power to the winch by the controller using at least one of a relay or a solenoid between the winch power supply and the winch.

15. The method of operating an electric vehicle of claim 13, wherein the at least one condition comprises one or more of a vehicle operating mode, a vehicle speed, a vehicle power mode, or a vehicle power status.

16. The method of operating an electric vehicle of claim 13, wherein the at least one condition comprises a vehicle speed, and wherein the predetermined requirement comprises a vehicle speed below a predetermined threshold.

17. The method of operating an electric vehicle of claim 13, further comprising:
determining the at least one condition based on one or more signals received from at least one sensor of the vehicle.

18. The method of operating an electric vehicle of claim 12, wherein the battery of the electric powertrain is a high-voltage battery of more than 100-volts, wherein the winch battery is less than 50-volts.

19. The method of operating an electric vehicle of claim 18, further comprising:
powering accessories of the vehicle other than the winch with an accessory system comprising an accessory battery, wherein the accessory battery is less than 50-volts.

20. The method of operating an electric vehicle of claim 19, wherein accessories of the vehicle other than the winch comprise an advanced driver assistance system (ADAS).
